(19) United States
(12) Patent Application Publication
(10) Pub. No.: US 2020/0314992 A1
(43) Pub. Date: Oct. 1, 2020

(54) PLASMA TORCH HAVING MULTI-ELECTRODE FRONT ELECTRODE AND BUTTON-TYPE REAR ELECTRODE

(71) Applicant: KOREA HYDRO & NUCLEAR POWER CO., LTD., Gyeongsangbuk-do (KR)

(72) Inventors: Hyun-Je CHO, Daejeon (KR); Cheon-Woo KIM, Daejeon (KR); Sung-Hoon HONG, Daegu (KR); Mi-Hyun LEE, Daejeon (KR)

(21) Appl. No.: 16/765,582

(22) PCT Filed: Oct. 31, 2018
(86) PCT No.: PCT/KR2018/013093

§ 371 Date: May 20, 2020

(30) Foreign Application Priority Data
Nov. 30, 2017 (KR) 10-2017-0163293

(51) Int. Cl. H05H 1/34

(52) U.S. Cl. CPC H05H 1/34; H05H 2001/3452; H05H 2001/3442; H05H 2001/3478

(57) ABSTRACT

A plasma torch has a multi-electrode front electrode and a button-type rear electrode. The plasma torch allows initial discharge to be easily performed by using the button-type rear electrode and an auxiliary electrode for discharge. Initial ignition of a high-output arc plasma torch is performed easily by naturally forming an arc column between the rear electrode and the front electrode, even in the absence of efficient discharge between the rear electrode and the auxiliary electrode for initial discharge.

### TECHNICAL FIELD

The present invention relates generally to a plasma torch. More particularly, the present invention relates to a plasma torch having a multi-electrode front electrode and a button-type rear electrode.

### BACKGROUND ART

Generally, in the case of a bar nozzle-type or hollow-type torch, the entire inner surface of each of electrodes provided in a nozzle or hollow type is a conductor and is configured as a structure that can receive an arc current anywhere. In this case, during torch ignition, abnormal or side arcing partially occurs, which acts as an obstacle to the stable operation of the torch.

In addition, as for a torch having a button-type rear electrode, when initial discharge is performed by the button-type rear electrode and a front electrode located at the exit of a torch flame, the initial ignition of the torch tends to be difficult, and the loss rate of the rear electrode configured in a button type may increase.

As for the plasma flame of the hollow-type torch, an arc point provided on the inner surface of the electrode can freely move throughout the inner surface. Since the length of arc formed between an anode and a cathode is determined within the range of the length between the electrodes configured as conductors according to operation condition such as an arc current and gas flow rate, the stability of the electrode is most important when the initial plasma is generated. For example, when a gas flow rate is increased, the arc point is pushed by the flow of gas, whereby arc length and arc voltage can be increased. However, even in this case, the length of the increased arc is limited by the length between the electrodes provided in a nozzle type or hollow type, and when the arc current is increased, the arc length can be reduced again by a Lorentz force, etc.

However, in the case of hollow-type multiple electrodes, the lifespan thereof can be extended, but when the problem of a rear electrode generating plasma occurs, it is difficult to replace the rear electrode. Furthermore, in the case of a button-type rear electrode, it is easy to replace the button-type rear electrode, but initial ignition may be difficult.

### Document of Related Art

(Patent Document 1)

Korean Patent No. 10-1629683 (registered on Jun. 7, 2016)

### DISCLOSURE

### Technical Problem

The present invention has been made keeping in mind the above problems occurring in the prior art, and the present invention is intended to provide a plasma torch having a multi-electrode front electrode and a button-type rear electrode, which allows initial discharge to be easily performed by using the button-type rear electrode and an auxiliary electrode for discharge.

In addition, the present invention is intended to provide a plasma torch having the multi-electrode front electrode and the button-type rear electrode, wherein the rear electrode is configured in an insertion type and the front electrode is configured as multiple electrodes to extend the life of the electrodes.

### Technical Solution

The present invention provides a plasma torch having a multi-electrode front electrode and a button-type rear electrode, the plasma torch including: a rear electrode of an anode or a cathode seated on a first side of an insulating body and configured in a button type; a front electrode of an anode or cathode seated on a second side of the insulating body and configured as multiple electrodes; and a constrictor part provided between the rear electrode and the front electrode, the constrictor part having multiple constrictors which are electrically insulated.

The rear electrode may be configured in an insertion type and the front electrode may be configured in a removable type.

The plasma torch may further include: an auxiliary electrode for initial discharge arranged between the front electrode and the rear electrode, the auxiliary electrode being electrically insulated.

The constrictor part may include a constrictor expansion part configured as an auxiliary electrode, the constrictor expansion part allowing the constrictors to be expanded toward the front electrode such that the constrictor part is connected to the front electrode.

The front electrode may be multiply configured, so that the front electrode may be configured to have the same pole as a pole of the auxiliary electrode for initial discharge and may be electrically connected to the button-type rear electrode to have polarity opposite to polarity of the button-type rear electrode inserted into a rear of the plasma torch.

In addition, after the constrictor part is ignited by the auxiliary electrode for initial discharge arranged between the front electrode and the rear electrode, the constrictor part may control a voltage and gas such that a plasma flame is produced by the rear electrode and the front electrode.

### Advantageous Effects

Due to the above-described technical configuration, the plasma torch of the present invention allows initial discharge to be easily performed by using the button-type rear electrode and the auxiliary electrode for discharge, and initial ignition of a high-output arc plasma torch to be easily performed by naturally forming an arc column between the rear electrode and the front electrode even in the absence of efficient discharge between the rear electrode and the auxiliary electrode for initial discharge.

### DESCRIPTION OF DRAWINGS

FIG. 1 is a view illustrating a plasma torch having a multi-electrode front electrode and a button-type rear electrode according to an embodiment of the present invention.

FIG. 2 is a view illustrating the electrical connection of the plasma torch having the multi-electrode front electrode and the button-type rear electrode according to the embodiment of the present invention.

### BEST MODE

Hereinbelow, the present invention will be described in detail with reference to the accompanying drawings. However, the accompanying drawings may be exaggerated, omitted, or roughly illustrated for the convenience of description of the main parts, and terms used in the description of the present invention may be implicitly defined by the shape, function, and role of the configuration of the present invention rather than the dictionary meaning, and the description of location is based on the drawings unless otherwise specified. In addition, the detailed description of the pre-registered known technology and the conventional technology may obscure the subject matter and may be omitted or replaced with simple reference numerals or names.

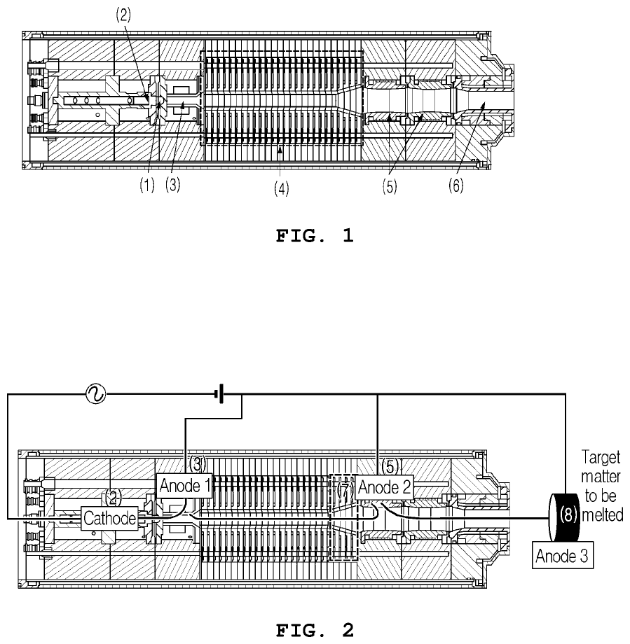

FIG. 1 is a view illustrating a plasma torch having a multi-electrode front electrode and a button-type rear electrode according to an embodiment of the present invention.

As illustrated in FIG. 1, the plasma torch may include the rear electrode 1, the front electrode 5, a constrictor part 4, and an auxiliary electrode 3 for initial discharge.

The rear electrode 1 is a rear electrode of an anode or a cathode that is seated on a first side of an insulating body and is configured in a button type. Such a rear electrode 1 may be configured in an insertion type.

The front electrode 5 is a front electrode of an anode or a cathode, which is seated on a second side of the insulating body and is configured as multiple electrodes. Such a front electrode 5 may be configured in a removable type.

The front electrode 5 according to the embodiment is multiply configured, so that the front electrode 5 is configured to have the same pole as pole of the auxiliary electrode for initial discharge and is electrically connected to the button-type rear electrode to have polarity opposite to polarity of the button-type rear electrode inserted into a rear of the plasma torch.

The constrictor part 4 is provided between the rear electrode and the front electrode, the constrictor part having multiple constrictors, which are electrically insulated. The constrictor part may include a constrictor expansion part 7, the constrictor expansion part allowing the constrictors to be expanded toward the front electrode such that the constrictor expansion part can be used as an auxiliary electrode connecting the constrictor part to the front electrode.

After the constrictor part 4 according to the embodiment is ignited by the auxiliary electrode for initial discharge arranged between the front electrode and the rear electrode, the constrictor part can control a voltage and gas such that a plasma flame is stably produced by the rear electrode and the front electrode.

When such a plasma discharge is stably performed, the plasma flame is produced by the rear electrode 1 and the front electrode 5, and a target matter 8 is melted by a plasma flame guide 6.

The auxiliary electrode 3 for initial discharge is arranged between the front electrode and the rear electrode, and is an electrically insulated auxiliary electrode.

According to the embodiment of the present invention, the rear electrode (an anode or cathode) is configured in a button-type to form an electric arc, and the front electrode (the cathode or anode) is configured as the multiple electrodes, wherein multiple constrictors are provided between the rear electrode and the front electrode, the constrictors being electrically insulated. The rear electrode 1 may be configured in the insertion type and the front electrode may be configured in the removable type.

In addition, according to the plasma torch having a multi-electrode front electrode and a button-type rear electrode, the front electrode 5 is multiply configured, so that the front electrode 5 is configured to have the same pole as the pole of the auxiliary electrode 3 for initial discharge and is electrically connected to the button-type rear electrode to have polarity opposite to the polarity of the button-type rear electrode inserted into the rear of the plasma torch. After ignition by the rear electrode and the auxiliary electrode 3 for initial discharge, the constrictor part 4 stably controls a voltage and gas such that the plasma flame is stably produced by the rear electrode and the front electrode.

The plasma torch having a multi-electrode front electrode and a button-type rear electrode according to the embodiment of the present invention allows initial discharge to be easily performed by using the button-type rear electrode 1 and the auxiliary electrode 3 for discharge.

After the initial ignition, the constrictor part 4 controlling a voltage and gas allows a plasma bundle to be stably led forward by receiving gas constantly blown thereto to prevent arc from touching the wall surface thereof.

When the plasma discharge is stably performed, the plasma flame is produced by the rear electrode 1 and the front electrode 5, and the target material 8 is melted through the plasma flame guide 6.

In addition, the rear electrode is electrically connected as a button-type cathode (an anode) 2. In this case, after the auxiliary electrode 3 for initial discharge and the front electrode 5 as an anode (a cathode) are connected to DC pulse power, an arc column is formed between the rear electrode 1 and the auxiliary electrode 3 for initial discharge in order to easily induce initial discharge by DC pulse. Plasma gas thereinside is sufficiently heated by the arc column, and a plasma column is expanded by gas stably and constantly introduced through the constrictor part 4.

In addition, a normal plasma flame is stably and constantly maintained by the rear electrode 1 and the front electrode 5 and is released through the plasma flame guide 6.

Meanwhile, when the arc column formed between the cathode (the anode) of the rear electrode 1 and the auxiliary electrode 3 for initial discharge passes through the inside of the constrictor part 4, each disk-type component constituting the inside of the constrictor part 4 is configured such that a separate gas is introduced thereinto and a cooling flow path is individually formed therein, and thus serves to allow a gas flow rate to be stably formed.

In addition, the front electrode 5 having the multiple electrodes continues to use the auxiliary electrode 3 for initial discharge as an electrical channel of an auxiliary anode (a cathode) by separately using circuit resistance instead of performing electrical insulation by using the rear electrode 1 and a switch. Accordingly, the auxiliary electrode 3 for initial discharge and the front electrode 5 having the multiple electrodes can perform current distribution, thereby preventing sudden increase in torch output, and facilitating output control from low output to high output.

As described above, the plasma torch of the present invention has the auxiliary electrode 3 for initial discharge, which is electrically insulated, located between the cathode (the anode) 1 and the anode (the cathode) 5, and is a segmented torch of a disk type capable of stably increasing the length of arc by inserting multiple constrictor parts 4 controlling a voltage and gas between the auxiliary electrode 3 and the front electrode 5, wherein the constrictor expansion part 7 provided in the constrictor part 4 may be used as the auxiliary electrode such that the constrictor part is connected to the front electrode, thereby easily performing the initial ignition of a high-output arc plasma torch by naturally forming an arc column between the rear electrode and the front electrode even in the absence of efficient discharge between the rear electrode 1 and the auxiliary electrode 3 for initial discharge, and facilitating output control from low output to high output.

Furthermore, the rear electrode is configured in the insertion type to be easily removed, and the front electrode is configured as the multiple electrodes, thereby extending the lifespan of the electrodes to extend the lifespan of the torch.

Hereinafter, the application of the configuration proposed in the present invention will be described.

The present invention describes the configuration of the present invention and specific components included in the configuration to help understanding of the principles of the configuration to pursue in the present invention on the basis of the accompanying drawings. As for the configuration and the specific components included in the present invention, the structure, shape, arrangement, direction, and quantity thereof are determined in consideration of the principle to be pursued, and may be variously modified as necessary. The configuration and its specific components proposed in the present invention exemplify effects that those skilled in the art will intend to obtain in the present invention and which principle is most desirably applied to obtain better effects from the effects. Accordingly, it is most preferable to complete the present invention including all of the above-described configurations, but the present invention may be completed by selecting or excluding some of the above-described configurations according to cost reduction, convenience of manufacturing, environmental conditions, or needs, or one or some of the components may be separated therefrom and merged with other components to complete. Furthermore, each of the above-described components may be independently applied to other technical fields than the technical field of the present invention in consideration of principle, use, function, role, action, and effect.

As described above, all the description of the present invention is completed, and it seems that those skilled in the art can sufficiently appreciate the subject matter to be pursued in the present invention through the specific contents described above, and although described further, it is possible to infer sufficiently about the parts that have not been described. Accordingly, the claims of the present invention can be made by specifying the scope of rights as broadly as possible on the basis of the above-described description. Accordingly, those having ordinary skills in the art of the present invention and arts related to the present invention will appreciate that various modifications, additions and substitutions are possible, thereby further improving the efficiency of use as well as the development of this technological field and technological fields related thereto.

### DESCRIPTION OF THE REFERENCE NUMERALS IN THE DRAWINGS

1: Rear electrode
2: Rear electrode guide
3: Auxiliary electrode for initial discharge
4: Constrictor part
5: Front electrode
6: Plasma flame guide
7: Constrictor expansion part
8: Target matter to be melted

1. A plasma torch, comprising:
an insulating body;
a rear electrode, seated on a first side of the insulating body, the rear electrode of an anode or a cathode configured as a button type;
a front electrode, seated on a second side of the insulating body, the front electrode of an anode or a cathode configured as multiple electrodes; and
a constrictor part, having multiple constrictors that are electrically insulated, arranged between the rear electrode and the front electrode.

2. The plasma torch of claim 1, wherein:
the rear electrode is configured in an insertion type; and
the front electrode is configured in a removable type.

3. The plasma torch of claim 1, further comprising:
an auxiliary electrode for initial discharge, arranged in an electrically insulated manner between the front electrode and the rear electrode.

4. The plasma torch of claim 1, wherein:
the constrictor part comprises a constrictor expansion part that allows the multiple constrictors to expand toward the front electrode such that the constrictor part is connected to the front electrode, the constrictor expansion part being configured as an auxiliary electrode.

5. The plasma torch of claim 1, wherein:
the front electrode is multiply configured, with the front electrode having a polarity identical to a polarity of an auxiliary electrode for initial discharge and is electrically connected to the button-type rear electrode to have a polarity opposite to a polarity of the button-type rear electrode.

6. The plasma torch of claim 1, further comprising: an auxiliary electrode for initial discharge, arranged between the front electrode and the rear electrode, that ignites the constrictor part, which thereafter controls a voltage and gas, producing a plasma flame from the rear electrode and the front electrode.
